(19) United States
(12) Patent Application Publication
(10) Pub. No.: US 2009/0129088 A1
(43) Pub. Date: May 21, 2009

(54) Light Module and Light System

(76) Inventor: Udo Custodis, Hong Kong (HK)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/991,570

(22) PCT Filed: Sep. 21, 2006
(86) PCT No.: PCT/EP2006/066611

§ 371 Date: Mar. 10, 2008

(30) Foreign Application Priority Data
Sep. 23, 2005 (DE) 102005045649.9

(51) Int. Cl. F21V 17/00

(52) U.S. Cl. 362/249.05; 362/285

(57) ABSTRACT

The invention relates to a light module comprising a backlit surface element, a light source flatly applied to said surface element or connected thereto and to a light system comprising a plurality of said light modules.

### TECHNICAL FIELD

The invention relates to a light module with a backlit surface element in accordance with the preamble of patent claim 1 and to a light system for forming a backlit area.

### PRIOR ART

Backlighting a surface element has been known for years from, for example, advertisement boards, traffic signals and direction signs. Recently, however, there has been a demand for individual backlighting of individual subsurface elements, which are assembled to form a mosaic area. This has been observed to an increased extent in the sanitation sector, in which targeted backlighting of individual tiles of a tiled area is desired. In order to backlight the respective tiles, US 2005/0116667 A1, for example, proposes, in FIG. 46, backlighting the individual tiles by means of a light-emitting diode (LED) which has been inserted into a mount. One disadvantage with this solution, however, is the fact that uniform, flat backlighting of the tiles is not achieved by means of the LED. A further disadvantage is the fact that the LED and the mount have a relatively high physical height.

### DESCRIPTION OF THE INVENTION

The invention is based on the object of providing a light module with a backlit surface element which allows substantially uniform illumination of a surface element and has a low physical height. Furthermore, it is the object of the invention to provide a light system for forming a backlit area.

These objects are achieved by a light module having the features as claimed in patent claim 1 or by a light system having the features as claimed in patent claim 10. Particularly advantageous embodiments of the invention are described in the dependent patent claims.

The light module according to the invention has a surface element, which is backlit by means of a light source. According to the invention, the light source bears flat against the surface element or is connected to it. The flat arrangement of the light source on the surface element means that the latter is backlit over the whole area and in particular uniformly. As a result, a very good backlighting effect can be achieved since the surface element does not have only one LED directed at it as in the above-described prior art. Furthermore, an advantage of the solution according to the invention is the fact that the mount for holding the light source is no longer required, with the result that the light module has a very low physical height.

The light system according to the invention has a large number of light modules according to the invention. In this case, the light system can be matched to any desired mosaic areas in particular

as a result of the flexible relative arrangement of the light modules in relation to one another and as a result of the free shaping of the light modules.

The light source is preferably an electroluminescence light foil or a corresponding organic LED surface light.

In order to avoid damage to the light source, it can be covered at the rear by a protective layer, for example a vapor barrier.

In order to fix the light module on a fixing surface, it may be advantageous if the protective layer is covered at the rear by a backing layer, for example made from plastic.

In order to be able to connect adjacent light modules electrically to one another, each light module can have at least one plug. This is preferably fixed in the backing layer and can protrude at the side or at the rear, i.e. in the direction of the fixing surface. If the plugs extend in the direction of the fixing surface it is advantageous if a connecting body can be inserted into a receptacle of the fixing surface, which connecting body can be used to produce the electrical contact between the plugs of the adjacent light modules.

In order to enable individual driving of the light modules, they can have a switch, which is preferably arranged in the region of intersecting conductor tracks for looping through the current from one light module to the next light module and is protected against damage in the backing layer.

### BRIEF DESCRIPTION OF THE DRAWINGS

The invention will be explained below with reference to preferred exemplary embodiments. In the drawings:

FIG. 1 shows a plan view of a light system according to the invention;

FIG. 2 shows an enlarged side view of a light module from FIG. 1;

FIG. 3 shows an enlarged cross section through two interconnected light modules in accordance with a first exemplary embodiment; and

FIG. 4 shows an enlarged cross section through two interconnected light modules in accordance with a second exemplary embodiment.

### PREFERRED EMBODIMENTS OF THE INVENTION

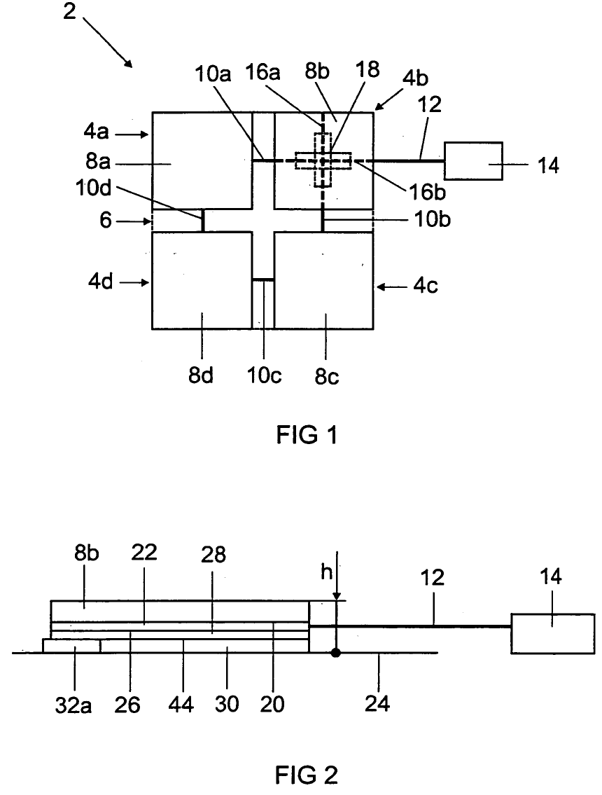

FIG. 1 show a very simplified plan view of a light system 2 according to the invention with a large number of light modules 4a, 4b, 4c, 4d according to the invention, which in their entirety form a mosaic area 6 of surface elements 8a, 8b, 8c, 8d which can be backlit, gaps or joins shown between the individual light modules 4a to 4d being illustrated as being very enlarged. The light modules 4a to 4d, as explained in particular with reference to FIG. 2, can have any desired shapes and materials and can be combined with one another in a flexible manner, with the result that this light system 2 is suitable for forming any desired mosaic areas 6.

The light modules 4a to 4d are electrically connected to the directly adjacent light modules 4a to 4d via in each case one plug-type connection 10a to 10d. The light module 4b is connected to a ballast 14 via a power supply line 12, which ballast 14 is electrically connected to a current source (not illustrated). In order to loop through the current from one light module to an adjacent light module, for example from the light module 8b to the light module 8c, the light modules 4a to 4d preferably have conductor tracks 16a, 16b which are indicated by dashed-dotted lines and which run in the interior of said light modules. The conductor tracks 16a, 16b are electrically connected in each case at least with one end section to a plug-type connection 10a to 10d and are arranged approximately at a 90° angle with respect to one another, with the result that an area of intersection or overlap is created. In the area of intersection of the conductor tracks 16a, 16b, the light modules 4a to 4d each have a switch 18 which acts as a distribution cross and by means of which the supply of current to the respective light module 4a to 4d can be interrupted, with the result that the light modules 4a to 4d can be driven or addressed individually. The actuation of the respective switch 18 takes place via a signal, which is likewise transmitted via the conductor tracks 16a, 16b as well as the current.

As is illustrated by way of example with reference to the light module 4b in FIG. 2, the surface elements 8a to 8d are each an integral part of the light modules 4a to 4d. As shown by FIG. 1, they have a tile-like design and substantially consist of a transparent material such as glass or plastic, for example. However, they can also consist of a different material such as ceramic, marble or slate,

the layer thickness or layer height being selected to be thin such that these materials also act in a light-transmissive manner. In principle, the configuration and the material are freely selectable and depend on the respective mosaic area 6 to be formed. Likewise, the plug-type connections 10a to 10d can be formed at any desired sections of the light modules 4a to 4d and their number can be freely selected, with the result that the light modules 4a to 4d are combined with one another or can be arranged in relation to one another in any desired manner.

In each case one light source 22 is arranged flat on an inner surface 20 of the surface elements 8a to 8d. The light source 22 is preferably an electroluminescence foil (EL foil) or an organic LED surface light (OLED surface light) and is connected directly to the surface element 8a to 8d, with it extending ideally over the entire inner surface 20. The direct connection can take place, for example, via a suitable adhesive or artificial resin. The light source 22 can also be arranged on an outer surface of the surface elements 8a to 8d which is remote from the inner surface 20, however. It is, however, also conceivable for the light source 22 to be applied detachably to the inner surface 20, so that it can be exchanged easily and quickly.

The supply of electricity to the light source 22 takes place in the case of the light module 4b via the power supply line 12, which, as has already been described in FIG. 1, is connected to the ballast 14. As a result of the direct arrangement of the light sources 22 on the respective surface elements 8a to 8d and their flat extent, very low physical heights can be realized. Thus, for example, light modules 4a to 4d with a total physical height h of less than 5 mm

are possible, with the result that, when the light modules 4a to 4d are positioned on a fixing surface 24, they do not protrude very much.

A protective layer 28 for avoiding damage to the light source 22 is applied to a large surface 26, which is remote from the inner surface 20, of the light source 22, i.e. on the rear. As a result of the hygroscopic properties of the light source 22, it is advantageous if the protective layer 28 is in the form of a vapor barrier, with the result that in particular the life of the light source 22 can be extended.

In order to arrange the light modules 4a to 4d on the fixing surface 24, for example a wall, a rear side 44, which is remote from the light source 22, of the protective layer 28 is covered by a preferably plastic-like backing layer 30, onto which, for example, mortar can be applied in order to fix the respective light module 4a to 4d to the wall. The light modules 4a to 4d therefore each have a sandwich-like construction, with the light source 22 being arranged in a particularly protected manner by meant of the direct arrangement on the respective surface elements 8a to 8d and the covering at the rear by means of the protective layer 28, which in turn is covered by the backing layer 30. The risk of damage to the light source 22 can be further reduced if the backing layer 30 surrounds at least the protective layer 28 and the light source 22 in the form of a casing.

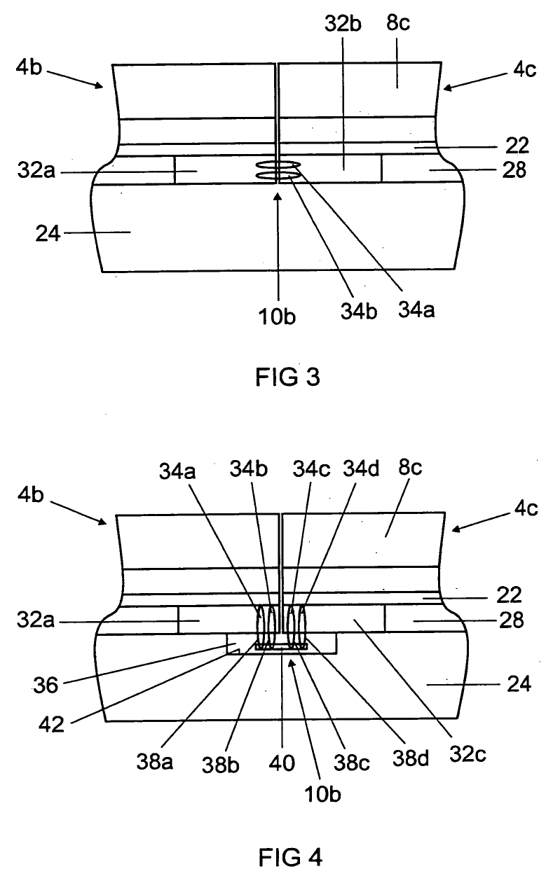

As shown in FIGS. 3 and 4, the plug-type connections 10a to 10d are each formed by at least two plugs 32a, 32b, which are electrically connected in each case

to the light source 22 of their light module 4a to 4d. In order to protect the plugs 32a, 32b from damage, at least sections of them are embedded in the backing layer 30 and terminate flush with it at the rear (FIG. 2). Likewise, the switches 18 are embedded in the backing layer 30 (not illustrated). The plugs 32a, 32b are arranged in the edge region of the light modules 4a to 4d and can be in the form of female or male plugs, in the embodiment in the form of male plugs 32a electrical connections or data transmission connections 34a, 34b protruding at the side, i.e. in the direction of an adjacent light module 4a to 4d, or at the rear, i.e. in the direction of the fixing surface 24 (FIGS. 3 and 4).

The lateral extent of the connections 34a, 34b of the male plug 32a have the advantage, as shown in FIG. 3, that on interaction with the female plug 32b of an adjacent light module 4c, the plugs 32a, 32b can be directly electrically and mechanically connected to one another by means of being pushed together laterally, with the result that the number of electrical interfaces for looping through the current is minimized.

The use of two male plugs 32a, 32c with a rear-side extent of their connections 34a, 34b, 34c, 34d has the advantage, as shown in FIG. 4, that the light modules 4a to 4d can be fixed detachably to the fixing surface 24 by means of their connections 34a, 34b, 34c, 34d, with the result that additional auxiliary means for fixing them to the fixing surface 24 can be dispensed with. For this purpose, a plate-like connecting body 36 is arranged in a receptacle 42

of the fixing surface 24, which connecting body 36 has corresponding holes 38a, 38b, 38c, 38d for the releasable engagement of the connections 34a to 34d. In order to produce an electrical connection between the light modules 4a to 4d and the respective plugs 32a, 32c, the connections 34a to 34d, in the inserted state, make contact, by means of their respective free end section, with a corresponding electrical contact element 40, which is accommodated in the connecting body 36 and delimits the holes 38a to 38d at the bottom.

The invention discloses a light module with a backlit surface element, against which a light source bears flat or is connected to it, and a light system with a large number of such light modules.

1. A light module with a surface element (8a to 8d), which is backlit by means of a light source (22), characterized in that the light source (22) bears flat against the surface element (8a to 8d) or is connected to it.

2. The light module as claimed in claim 1, the light source (22) being a light foil (EL foil) or a surface light (OLED).

3. The light module as claimed in claim 1 or 2, a section (26), which is remote from the surface element (8a to 8d), of the light source (22) being covered by a protective layer (28).

4. The light module as claimed in claim 3, the protective layer (28) being a vapor barrier.

5. The light module as claimed in claim 3, a section (44), which is remote from the light source (22), of the protective layer (28) being covered by a backing layer (30).

6. The light module as claimed in claim 1, at least one plug (32a, 32b, 32c) being provided for electrically connecting adjacent light modules (4a to 4d).

7. The light module as claimed in claim 6, the at least one plug (32a, 32b, 32c) protruding at the side or at the rear.

8. The light module as claimed in claim 6, the light module (4a to 4d) having a switch (18) for the purpose of individual driving.

9. The light module as claimed in claim 8, the at least one plug (32a, 32b, 32c) and the switch (18) being fixed in the backing layer (30).

10. A light system for forming a backlit area with a large number of light modules (4a to 4d) as claimed in claim 6.

11. The light system as claimed in claim 10, in each case one connecting body (36) being provided for the purpose of electrically connecting adjacent light modules (4a to 4d), said connecting body (36) being used to connect electrical plugs (32a, 32b, 32c) of the light modules (4a to 4d) to one another.

12. The light system as claimed in claim 11, the connecting body (36) being accommodated in a receptacle (42) of a fixing surface (24).
